(19) United States
(12) Patent Application Publication
(10) Pub. No.: US 2012/0158470 A1
(43) Pub. Date: Jun. 21, 2012

(54) SYSTEM FOR SUPPLY FORECASTING

(75) Inventors: Ramana Yerneni, Cupertino, CA (US); Saurabh Sodani, Lone Tree, CO (US)

(73) Assignee: Yahoo! Inc., Sunnyvale, CA (US)

(21) Appl. No.: 12/971,748

(22) Filed: Dec. 17, 2010

(51) Int. Cl. G06Q 30/00; G06Q 10/00; G06F 17/30

(52) U.S. Cl. 705/14.4; 707/769; 707/723; 705/1.1; 707/E17.014

(57) ABSTRACT

A method of forecasting a supply using data from a plurality of data servers is described. The method includes receiving a request for a supply forecast and sending a query for supply data to a plurality of data servers. The method also includes receiving the supply data from one or more of the plurality of data servers in response to the query. A response level is determined based on the received supply data, and is compared to a threshold level. The method also includes computing the supply forecast based on the received supply data when the response level equals or exceeds the threshold level.

### TECHNICAL FIELD

The present description relates generally to a system and method, generally referred to as a system, for supply forecasting.

### BACKGROUND

A market exists for the distribution of advertising and other information over data communications and entertainment networks. A non-limiting example is insertion of advertising copy supplied by advertisers, for appearance on web pages, content offered by media distributors such as news and information services, interne service providers, and suppliers of products related to the advertiser's products or services.

Despite the current economic forecasts, the surge in marketing budgets being diverted into digital continues unfettered. Digital media offers marketers a rapid, highly targeted, interactive, measurable and cost effective route to target consumers, something that may become even more important in times of uncertainty. With huge volumes of webpages being created daily, bringing with it a similar surge of new inventory, online publishers may seek to maximize their yields right across their properties by monetizing both their premium and unsold inventory. At the same time, the inventory may help online advertisers' source new opportunities to target their audience.

This growth is taking place in an environment of continuing media and audience fragmentation. However, it is the increasing complexities of reaching audiences that has driven the emergence of online advertising exchanges to provide efficiencies and reduce the complexities in an incredibly dynamic environment. Hundreds of millions of websites and huge volumes of online advertising are communicated around the world every day.

### SUMMARY

In one embodiment, a method of forecasting a supply using data from a plurality of data servers is described. The method includes receiving a request for a supply forecast and sending a query for supply data to a plurality of data servers. The method also includes receiving the supply data from one or more of the plurality of data servers in response to the query. A response level is determined based on the received supply data, and is compared to a threshold level. The method also includes computing the supply forecast based on the received supply data when the response level equals or exceeds the threshold level.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for distributing advertisement impressions.

FIG. 2 is a block diagram of an exemplary network environment and architecture for an advertising system.

FIG. 3 is a block diagram of an exemplary architecture for an inventory management system.

FIG. 4 is a block diagram of an exemplary architecture for an advertising system.

FIG. 5 is a flow/block diagram illustrating a method and system for supply forecasting.

FIG. 6 is a flow/block diagram illustrating a method and system for supply forecasting.

FIG. 7 is a flow/block diagram illustrating a method and system for supply forecasting.

FIG. 8 is a block diagram of an exemplary processing system for executing advertisement impression distribution systems and methods.

### DETAILED DESCRIPTION

A supply of advertisement impression opportunities may include opportunities to insert on-line advertising (“ad opportunities”). Alternatively and/or in addition, for example, variable banner ads may be inserted into web pages that are transmitted to users. Alternatively and/or in addition, an advertisement or advertiser listing may be inserted into a list of results returned in response to a user search query. Alternatively and/or in addition, for example, an advertisement or advertiser listing may be inserted when a user is playing a game on a web site, a mobile phone, or a smart phone. Alternatively and/or in addition, an advertisement or advertiser listing may be inserted when a user is using an application on a web site, on a mobile phone, or on a smart phone. Ad opportunities may arise anytime a user visits a page, enters a search query, plays a game on a website or phone, uses an application on a website or phone, or uses a search engine. For example, every web site view may be an ad opportunity.

Advertisements (“ads”) may be allocated selectively, based on characteristics of the user or typical users of the particular web page, or otherwise selected to match user and content information, location, timing and other criteria to advertiser specifications, for targeting the ads to potential customers.

In a display advertising system, ad campaigns may be booked for a future time period, and as such, the set of matching and/or relevant ad opportunities for a campaign being books may be forecasted opportunities rather than predetermined or otherwise permanent opportunities. Accordingly, these systems may include a component that forecasts the set of ad opportunities for potential ad campaigns being requested or booked.

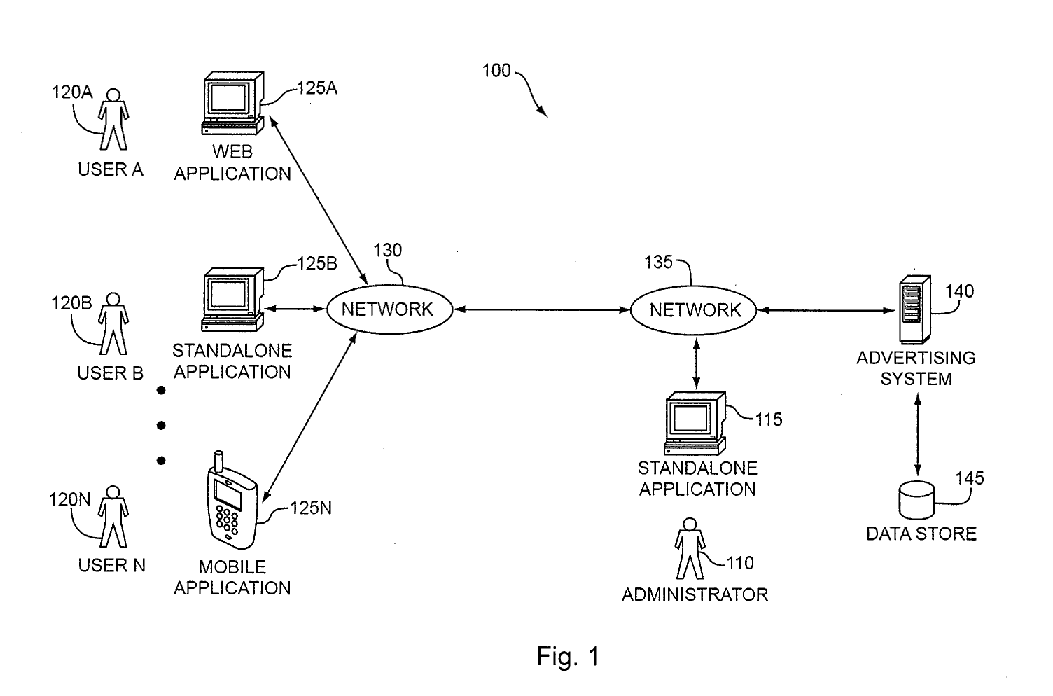

FIG. 1 provides a simplified view of a network environment 100 for forecasting advertisement supply and serving advertisements or advertisement impressions in an optimized way. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 100 may include an administrator 110 and one or more users 120A-N with access to one or more networks 130, 135, and one or more web applications, standalone applications, mobile applications 115, 125A-N, which may collectively be referred to as client applications. The network environment 100 may also include one or more advertisement systems 140 and related data stores 145. The users 120 A-N may request pages, such as web pages, via the web application, standalone application, mobile application 125 A-N, such as web browsers. The requested page may request an advertisement impression from the advertisement server 140 to fill a space on the page. The advertiser system 140 may serve one or more advertisement impressions to the pages. The advertisement impressions may include online graphical advertisements, such as in a unified marketplace for graphical advertisement impressions. Information about projected supply may be determined with a model that may be created, modified, and/or used by the advertisement system 140. Some or all of the advertisement system 140 and the one or more web applications, standalone application, mobile applications 115, 125A-N, may be in communication with each other by way of the networks 130 and 135.

The networks 130, 135 may include wide area networks (WAN), such as the Internet, local area networks (LAN), campus area networks, metropolitan area networks, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-N may be connected to the network 130 in any configuration that supports data transfer. This may include a data connection to the network 130 that may be wired or wireless. Any of the web applications, standalone applications and mobile applications 115, 125A-N may individually be referred to as a client application.

The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement system 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an interne connection, an infra-red connection, a Bluetooth connection, or any other connection capable of transmitting data. For example, the mobile application 125N may be an application running on an APPLE IPHONE®.

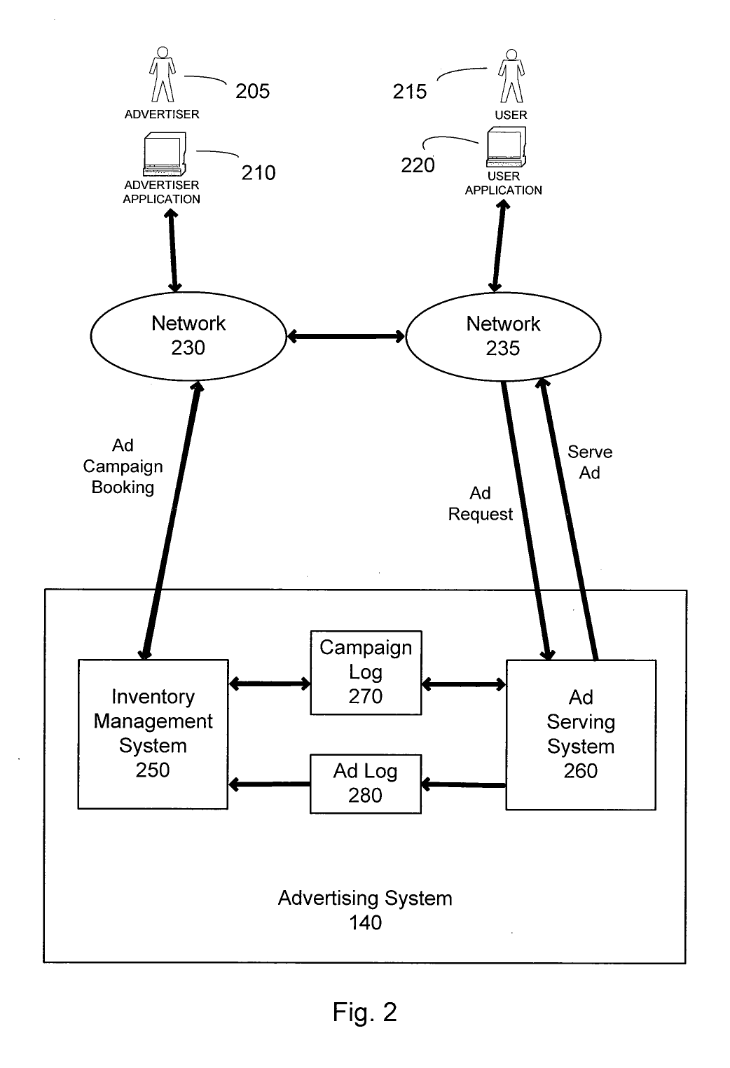

The advertisement system 140 may include one or more of the following: an ad serving system, an inventory management system, a campaign log, an ad log, and/or a data store. The advertisement system 140 may exist on one machine or may be running in a distributed configuration on one or more machines. The advertisement system 140 may be in communication with the client applications 115, 125A-N, such as over the networks 130, 135. For example, the advertisement system 140 may provide an interface to the users 120A-N through the client applications 125A-N, such as a user interface for inputting search requests and/or viewing web pages. Alternatively or in addition, the advertisement system 140 may provide a user interface to the administrator 110 via the client application 115, such as a user interface for managing the data source 145 and/or configuring advertisements. The users 120A-N may include advertisers, such as advertiser 205 shown in FIG. 2, and users, such as user 215 shown in FIG. 2.

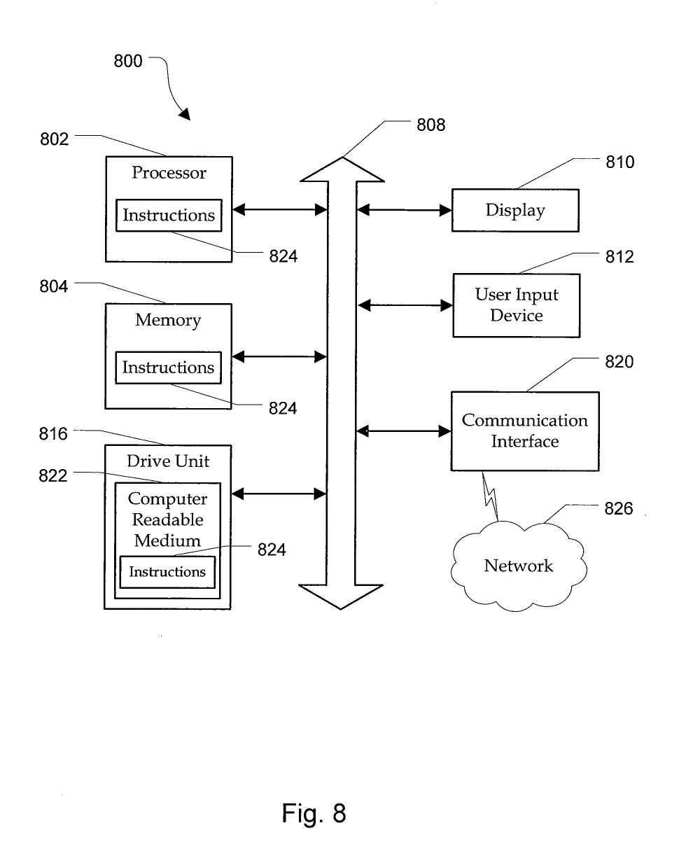

The advertisement system 140 and client applications 115, 125A-N may be one or more computing devices of various kinds, such as the computing device in FIG. 8. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 125A may employ the Hypertext Transfer Protocol (“HTTP”) to request information, such as a web page, from a web server, which may be a process executing on the advertisement system 140.

There may be several configurations of database servers, application servers, mobile application servers, and middleware applications included in the advertisement system 140. The data store 145 may be part of the advertisement system 140 and may be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols.

The networks 130, 135 may be configured to couple one computing device to another computing device to enable communication of data between the devices. The networks 130, 135 may generally be enabled to employ any form of machine-readable media for communicating information from one device to another. Each of networks 130, 135 may include one or more of a wireless network, a wired network, a local area network (LAN), a wide area network (WAN), a direct connection such as through a Universal Serial Bus (USB) port, and the like, and may include the set of interconnected networks that make up the Internet. The networks 130, 135 may include communication methods by which information may travel between computing devices.

Generally, advertisement campaigns (“ad campaigns”) may be used to organize an advertiser's advertisements, and may specify and/or designate to whom, when, where, and how an advertisement will be displayed, as well as what advertisement will be displayed. An advertiser may wish to set up or book ad campaigns with one or more advertisement systems, service providers, web publishers, or otherwise, in order to selectively consume available ad opportunities. Ad campaigns may specify matching values for a subset of attributes of ad opportunities or ad impressions that the ad campaigns target.

In arranging for or requesting information about an ad campaign, advertisers may wish to identify one or more ad campaign requirements or attributes which may be associated with an ad campaign and used to aid in or ensure that advertisements or other listings may be delivered in accordance with the requirements or desires of the advertiser. In addition, advertisers may identify a number of impressions or views which the advertiser may wish to purchase for the advertiser's advertisements. For example, an advertiser may contact an advertising system and request an ad campaign for 1 million views, with the advertiser's advertisement being shown only to males of a first age category.

An inventory management system may assist the advertiser in setting up ad campaigns. An early step for the inventory management system in setting up an ad campaign may be forecasting ad opportunities that satisfy or match the advertiser's ad campaign requirements. Based on the matching and/or relevant ad opportunities that may be available, an amount of available ad opportunities may be determined and a price for the creation of a new advertisement campaign meeting the requirements specified by the advertiser may be computed or otherwise determined. Pricing may be determined by the supply, the demand, and/or the amount of impressions requested by the advertiser.

With information about booked ad campaigns, as well as advertisements themselves, stored in campaign logs, the advertising system may accept requests for advertisements to be delivered, for example, to web pages or in response to search requests. The advertising system may consult booked ad campaigns and select advertisements from ad campaigns whose attributes and/or ad campaign requirements match the characteristics or attributes of the ad opportunity created by the requests.

FIG. 2 is a block diagram of an exemplary network environment with an advertising system 140. The advertising system 140 may include an ad serving system 260, a campaign log 270, an ad log 280, and an inventory management system 250. The advertising system 140 may be connected to one or more networks 230 and 235. A user 215 may interact with the advertising system 140, and may interact through the use of a user application 220. The user application 220 may be connected to the advertising system 140 through or using the network 235. An advertiser 205 may interact with the advertising system 140, and may interact through the use of an advertiser application 210. The advertiser application 220 may be connected to the advertising system 140 through or using the network 230.

The user 215 may, for example, be any of the users 120A-N. The user 215 may be involved in, for example, viewing a web page, searching for information using a search engine, viewing a display, or otherwise gathering information. The user 215 may or may not be aware of the advertising system 140 or any of its components.

The user application 220 may, for example, be a web application 125A, a standalone application 125B, a mobile application 125N, or any other application which may allow the user 215 to view and/or interact with the network 235 and/or the advertising system 140.

The advertiser 205 may, for example, be any of the users 120A-N. The advertiser 205 may be involved or interested in, for example, disseminating information. The advertiser 205 may wish to advertise the advertiser's businesses, products, or services. The advertiser 205 may, alternatively or additionally, wish to disseminate other information about the advertiser 205 or other information. For example, the advertiser 205 may be an airport or airline and may wish to disseminate information about flights. An advertiser 205 may include any individual, group of individuals, or entity that wishes to disseminate or otherwise distribute information to another individual, group of individuals, or entities.

Advertisements may include any information which an entity wishes to be disseminated to another. For example, advertisements may include information for or about an entity, product, or service. Alternatively or in addition, advertisements may include any other information, messages, data, or otherwise that an entity wishes to convey. Advertisers may be any individual, group of individuals, or entity which wishes to convey or disseminate any information, message, data, or otherwise to another.

The advertiser application 210 may, for example, be a web application 125A, a standalone application 125B, a mobile application 125N, or any other application which may allow the advertiser 205 to view and/or interact with the network 230 and/or the advertising system 140.

Network 230 may, for example, be a network like network 130 or network 135. Network 230 may be connected or otherwise in communication with the user 215, the user application 220, the advertising system 140, and/or any of the components of the advertising system 140.

Network 235 may, for example, be a network like network 130 or network 135. Network 235 may be connected or otherwise in communication with the advertiser 205, the advertiser application 210, the advertising system 140, and/or any of the components of the advertising system 140.

For illustrative purposes, networks 230 and 235 are shown as separate networks, but networks 230 and 235 may be one network. Networks 230 and 235 may be identical or different. Networks 230 and 235 may include a plurality of networks which may all be the same or different. Networks 130, 135, 230, 235, and 826 may include different networks connected together or all be part of the same network, or any combination thereof.

In general, the advertising system 140 may manage, assist in, and/or control the display of advertisements and/or other information to a user 215 when the user 215 seeks information, such as, for example, by visiting a web page or entering a query using a search engine. As mentioned, the advertising system 140 may include an inventory management system 250, an ad serving system 260, a campaign log 270, and an ad log 280.

As previously mentioned, the advertiser 205 may wish to create an ad campaign to monitor and manage a delivery of advertisements or other information related to the advertiser 205 to users such as user 215. The advertising system 140 may, for example, provide an interface through which the advertiser 205 may communicate with the advertising system 140. The advertiser 205 may query, request, or otherwise inquire about information regarding setting up or booking an ad campaign with the advertising system 140.

The advertiser 205 may wish to target advertisements or information to a particular type of user, during a particular time period, and/or in a particular manner. The purpose of the ad campaign which the advertiser 205 may seek to set up may be to organize and/or simplify the efforts of the advertiser 205 and to allow the advertiser 205 to target advertisements and information as desired.

In order to set up and/or book an ad campaign, however, an advertising system 140 may wish to determine or ensure that it has a sufficient supply of advertising opportunities which may be available to the advertiser 205, should the advertiser 205 set up an advertising campaign. The advertising system 140 may wish to gather, from the advertiser 205, one or more characteristics and/or attributes that the advertiser 205 may desire or require of ad opportunities that the advertiser 205 is interested in acquiring for display of the advertiser's advertisements. For example, the advertiser 205 may wish to serve its advertisements only to males of a first age category in the state of California.

Accordingly, in inquiring or requesting information on booking an ad campaign, the advertising system 140 may allow the advertiser 205 to specify one or more of these or other attributes or ad campaign requirements (“attributes”). As mentioned, attributes may identify one or more requirements or characteristics of ad opportunities required or desired by the advertiser. Attributes may be related to one or more attribute types, and may, for example, identify a particular subset of the population which the advertiser may wish to display advertisements or information to, a position or placement of an advertisement, a timing of an advertisement, qualifications or pre-requisites necessary for the display of an advertisement, or any other type of information pertaining to a potential viewer of an advertisement, or placement, location, type, or timing of an advertisement.

Attribute types may include, for example, a position of the advertisement, a content topic of the page or display, a gender of the potential viewer, an age or age category of the potential viewer, a location of the advertisement, a behavior tag. Attribute types may also or alternatively include, for example, a device identifier (such as a user or device specific identification number or name) or device type (such as an iPad, mobile phone, laptop, etc.) on which a user is viewing content. Attribute types may also or alternatively include, for example, a time of day, day of the week, and/or other timing information for the ad impression. Attribute types may specify or clarify one or more of characteristics of an ad opportunity or display, such as who may view an advertisement and what is the viewer interested in or is the content of the opportunity and/or type of advertisement to fill it. In addition, attributes may specify or clarify when, where, and how an advertisement may be displayed to fill the ad opportunity. Any number of attribute types may exist.

The advertiser 205 may input an attribute for one or more attribute type. For example, the advertiser 205 may input “Sports” for an attribute type “Content Topic.” The advertiser 205 may input one or more than one attribute for each attribute type. The advertiser 205 may choose not enter an attribute for one or more of the attribute types. The advertiser 205 may, in some embodiments, only enter an attribute for those attribute types which the advertiser 205 has a particular interest in identifying, and may not enter attributes for attribute types which the advertiser 205 does not have any preferences for.

The advertiser 205 may input the attributes using a menu or listing provided by the advertising system 140. For example, the advertising system 140 may provide a drop down menu for each attribute which, when interacted with by the advertiser 205, displays a list of possible attributes selectable by the advertiser for that attribute type. Alternatively, the advertising system may provide a text box for each attribute type, into which the advertiser may enter the attribute. In addition or alternatively, the advertising system 140 may automatically gather one or more attributes from the advertiser, such as, for example, by using information previously gathered by the advertiser or using cookies or other data collected or collectable from the advertiser. Any other method of inputting or gathering an attribute is possible.

Attributes may be identified in the negative. For example, an advertiser 205 may input or otherwise indicate “NOT Sports” into the attribute type “Content Topic.” In this manner, the advertiser 205 may specify that it does not wish for its ad campaign to be associated with ad opportunities with a content topic of “Sports.” Where a drop down menu or other listing is provided by the advertising system 140, the menu or listing may include a tab, button, clickable indicator, or other manner of indicating that the input is a negative input.

Attributes may be gathered, input, or otherwise supplied to the advertising system 140 at any point. For example, the advertiser 205 may input one or more attributes when the advertiser 205 initially interacts with the advertising system 140, or at any other point. In some embodiments, the advertising system 140 may prompt the advertiser for one or more attributes, such as after the advertiser 205 has initially interacted with the advertising system 140. The advertising system 140 may alternatively, or in addition, gather one or more attributes from the advertiser 205 automatically upon the advertiser's initial interaction with the advertising system 140.

As shown in FIG. 2, the request or inquiry for ad campaign booking information from the advertiser 205 may be directed to the inventory management system 250 of the advertising system 140. As mentioned, this inquiry or request may be accompanied by one or more attributes or ad campaign requirements for the advertiser. The request or inquiry and/or attributes may be directly sent to the inventory management system 250 by the advertiser 205, or may be directed or sent by the advertiser 205 to the advertising system 140, and then directed to the inventory management system 250 by the advertising system 140.

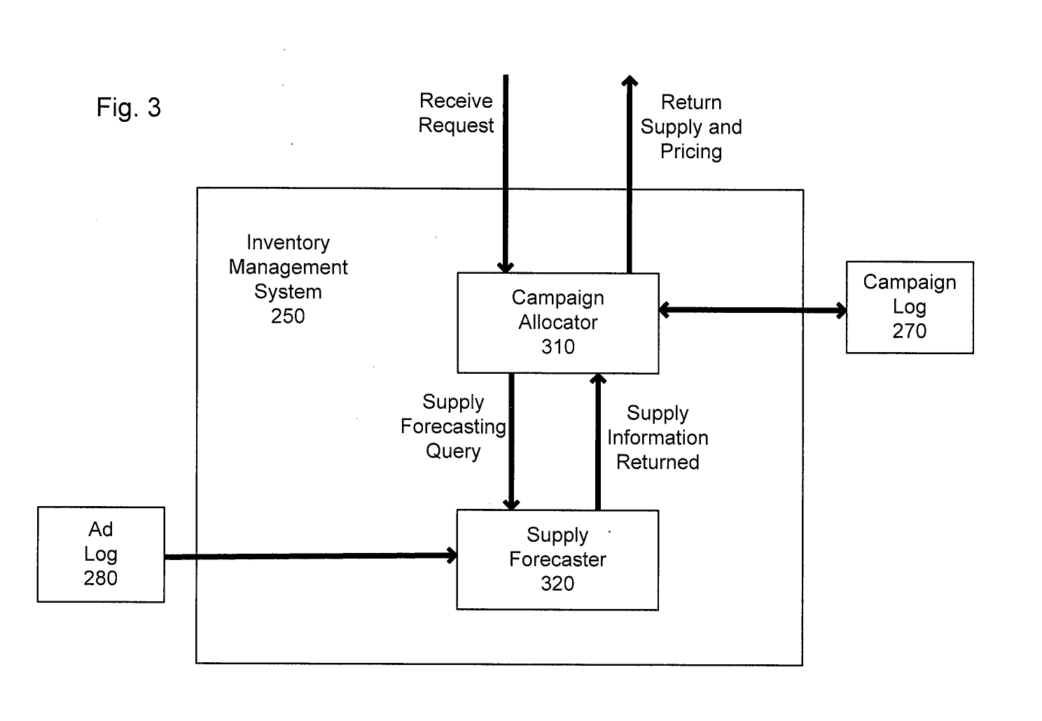

As shown in FIG. 3, the inventory management system 250 may include a campaign allocator 310 and a supply forecaster 320. In some embodiments, the campaign allocator 310 and the supply forecaster 320 may be the same component, and in other embodiments, they may be separate. The inventory management system 250 may be connected to or otherwise in communication with the campaign log 270. For example, as shown in FIG. 3, the campaign log 270 may be in communication with the campaign allocator 310 of the inventory management system 250. The inventory management system 250 may also be connected to or otherwise in communication with the ad log 280. For example, as shown in FIG. 3, the ad log 280 may be in communication with the supply forecaster 320. Any other configurations or connections between the inventory management system 250, the campaign log 270, and the ad log 280 may be possible.

The inventory management system 250 may be designed, operable, constructed, or otherwise configured to assist in the creation and/or booking of an ad campaign. The inventory management system 250 may be responsible for both forecasting a supply, such as determining a number of possible advertisement opportunities, and also for allocating the supply to the demand.

As shown in FIG. 3, the inventory management system 250 may receive the request or inquiry, along with any possible attributes or ad campaign requirements, from an advertiser 205. The request may, for example, be for information about booking an advertisement campaign, supply information, an offer or other details about booking an ad campaign, and/or any other information related to ad campaigns.

When an inquiry or request is received by the inventory management system 250, the inquiry or request may be directed to the campaign allocator 310. The campaign allocator 310 may assist in, be responsible for, or otherwise participate in determining an allocation of possible supply with known or projected demands. The campaign allocator 310 may seek supply information which the campaign allocator 310 may then use in allocating the supply with the demand. The campaign allocator 310 may request supply data and/or information from the supply forecaster 320. The supply data and/or information requested by the campaign allocator 310 may include a request for a predicted amount of ad opportunities which match or are relevant to the attributes and/or ad campaign requirements specified by the advertiser 205. The campaign allocator 310 may include the attributes in the request.

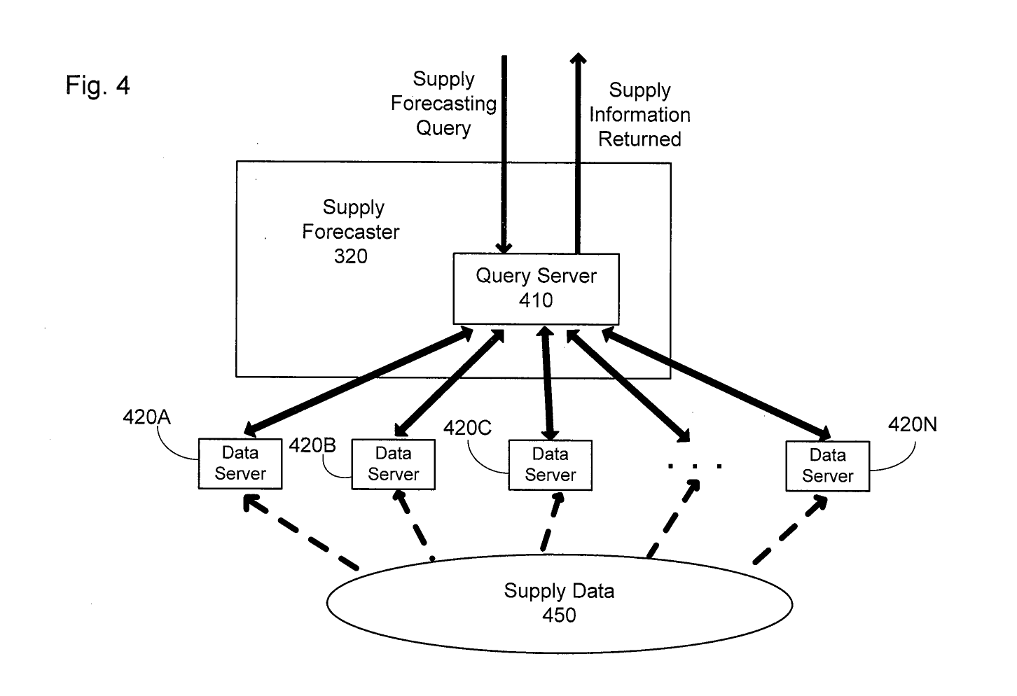

As shown in FIG. 4, the supply forecaster 320 may include, for example, a query server 410. The supply forecaster 320 may receive the request for supply data and/or information from the campaign allocator 310, as well as the attributes specified by the advertiser 205. The request for supply data and/or information may be, for example, a request for general information about an available supply. The request for supply data and/or information may, alternatively or in addition, include a request for samples and/or weight for the supply. The request for supply data and/or information may be, alternatively or in addition, a request for a forecasted supply based on historical counts of ad impressions and/or trends. Other information or requests are possible.

The request or inquiry from the campaign allocator 310 may be, for example, directly sent to the query server 410, or may be generally sent to the supply forecaster 320 and then directed by the supply forecaster 320 to the query server 410. In other embodiments, the initial request or query from the advertiser 205 for ad campaign information may be directly sent to the supply forecaster 320 or query server 410.

As mentioned, supply forecaster 320 may be asked to determine a supply of advertising opportunities that may be assigned or otherwise reserved by the advertiser 205. For example, the supply forecaster 320 may be tasked with determining a supply of advertising opportunities which match the attributes or ad campaign requirements presented by the advertiser 205. As mentioned, due to the nature of online advertising, the advertiser 205 may not have a hard and fast, or otherwise permanent, set of advertising opportunities which are known and certain to take place in the future. Rather, the supply forecaster 320 may look to data about previous advertising impressions in order to forecast, estimate, and/or predict the number of similar advertising opportunities likely to occur in the future.

For example, if an advertiser 205 inputs attributes or ad campaign requirements such as “Content Type=mortgages; Dates=Jan. 1, 2011-Jan. 15, 2011; Gender=Male” and made a booking request on, for example, Dec. 1, 2010, it may not be possible for the supply forecaster 320 to know precisely how many advertising opportunities will arise between the dates specified related to mortgages and males. However, the supply forecaster 320 may be able to predict how many advertising opportunities may exist during that period by using a supply forecasting model (sometimes referred to as “forecast model,” “forecasting model,” or “forecasting system”) and, for example, determining how many ad impressions occurred during a similar time period or under similar circumstances. For example, the supply forecaster 320 may look to see how many ad impressions related to mortgages and males occurred during Jan. 1, 2010-Jan. 15, 2010. In addition, or alternatively, the supply forecaster 320 may take into account more recent trends in ad impressions, such as how many ad impressions related to mortgages and males have occurred in the last 15 days. In some embodiments, the supply forecaster 320 may, alternatively or in addition, look at ad impressions for related websites. For example, the forecast trend for content topic=mortgages may be similar to the forecast trend for content topic=finance, and as such, the supply forecaster 320 may look at ad impressions dealing with mortgages and/or finance for forecasting supply for either mortgages or finance. This may be useful, for example, in cases where a particular target may have a small number of impressions. There, forecasting models may use the trend of a coarser granularity pool of impressions to get a large enough pool that exhibits predictable trends. The supply forecaster 320 may look to any number of time periods and/or similar occurrences to gather data which may be useful with a supply forecasting model for determining, predicting, forecasting, and/or estimating a supply in accordance with requested attributes or ad campaign requirements.

Each factor and set of data may be considered and/or input into a supply forecast model in, for example, the supply forecaster 320, to generate an expected supply of ad opportunities. Historical counts and trends may be used by the supply forecaster 320 and/or supply forecast models to forecast future counts and trends for supply. In this way, the supply forecaster 320 may be able to review past ad impressions and determine, forecast, predict, and/or estimate a future supply.

FIG. 4 illustrates a plurality of data servers 420A-N. Large amounts of data and information about past advertisement impressions, collectively referred to as supply data 450, may be stored in or otherwise accessible to or from the data servers 420A-N. In some embodiments, one or more of the data servers 420A-N may additionally contain a partition or subset of a forecasting model, which may be used by the data servers to return a partial or subset of a forecasted supply.

The data servers 420A-N may store data about all previous advertisement impressions or opportunities from a previous given time frame, such as over the last five years. The supply data 450 may also include attribute information about each ad impression. The supply data 450 may include attributes for some or all of the attribute types for each ad impression. For example, the supply data 450 may include a record of some or all ad impressions made on any particular system, and/or over any particular time period, and may further include attribute information about the characteristics of the viewer of the advertisement impression, as well as the timing, placement, surrounding content, or other information about the ad impression.

These ad impressions and attributes and/or characteristics about ad impressions may be gathered by the ad serving system 260 from any user who views the ad impression. For example, this information may be collected from using cookie information, user log-in information, or an analysis of IP information. Alternatively or additionally, some or all of the information may be volunteered by the user. In some embodiments, anytime the ad serving system 260 serves an ad, ad impression information is recorded and added to the supply data 450.

Given that a system may encounter, for example, 20 billion or more ad opportunities or impressions a day, the supply data 450 may be on the order of trillions or more of ad impressions and opportunities. Accordingly, this data may be partitioned across a set of multiple data servers 420A-N. This may be done to alleviate possible storage concerns and/or to allow for more efficient sorting or searching of the information or data. The wealth of information stored in the data servers 420A-N may be used by the supply forecaster 320 to aid in determining a predicted supply of ad opportunities which may be available in the future.

In reviewing and gathering data on past ad impressions, it may be the goal of the supply forecaster 320 to determine when a past ad impression matches attributes or ad campaign requirements of the advertiser 205. An ad impression may match or qualify as relevant for a campaign when the values of its attributes satisfy the conditions specified by the campaign. In some embodiments, an ad impression may match or be relevant if all of the attributes specified by the advertiser 205 are the same with the ad impression.

As an example, consider where three campaigns have been requested or booked:

Campaign 1 specifies: Content Topic=Sports; Location=CA.
Campaign 2 specifies: Content Topic=Finance; Age Category=2.
Campaign 3 specifies: Content Topic=Sports; Gender=Male.

An ad impression may have the following attributes: Content Topic=Sports; Gender=Male; Age Category=2; Location=CA; Behavior Tag=Politics. In this example, the ad impression matches Campaigns 1 and 3, but does not match Campaign 2. More or less attribute topics may be included in the ad impression.

In gathering information from the data servers 420A-N about past ad impressions, the query server 410 of the supply forecaster 320 may, upon receiving a request for supply data, supply information, and/or a supply forecast, request data or information from each of the data servers 420A-N. This request or query from the query server 410 may be sent to the data server 420A-N in parallel. This may be done in a load-balancing manner by scattering the requests to all data servers 420A-N in order to maximize an amount of data to be received, while minimizing time and effort in procuring the information. In requesting the data or information from each of the data servers 420A-N, the query server 410 may include the attributes specified by the advertiser 205. In some embodiments, the data servers 420A-N may be queried only for advertisement impressions or opportunities that match or are related to the attributes specified by the advertiser 205.

The query server 410 may request a total number of advertisement impressions or opportunities that match or are related to the attributes specified by the advertiser 205. The query server 410 may additionally or alternatively request one or more samples of advertising impressions or opportunities that match or are related to the attributes specified by the advertiser 205. The query server 410 may additionally or alternatively request a weight for each of the samples. The weight for each sample may represent a number of impressions in the data server which the sample is meant to represent.

In some embodiments, the query server 410 may request a designated and/or predetermined number of weighted supply samples. In these embodiments, each query result may be represented as a set of supply samples, where each sample has a weight associated with the amount of supply (ad opportunities) it represents. The query server 410 may expect a designated and/or predetermined number of samples to be returned from each data server. The total supply for a query may be the sum of the weights of the samples in the query result. Often, the number of matching/relevant ad impressions or opportunities may be very large, and by using the weighted samples as discussed, large amounts of data may be reduced for a faster and easier dissemination and analysis.

In some embodiments, the query server 410 may request or query the data servers 420A-N for a set of samples returned based on the total number of ad impressions matching/relevant to a set of attributes. The query server 410 may request from each data server 420A-N one sample be returned for every X of matching/relevant ad impressions, where X may be any number. For example, the query server 410 may request that each data server 420A-N send a sample for every 1000 ad impressions matching and/or relevant to a set of attributes. In these examples, the samples may or may not be weighted. The query server 410 may not expect or know how many samples may be returned, but the query server 410 may assume that the weight of the samples is X. The total supply for a query may be a sum of the number of returned samples multiplied by X, or the weight of each sample.

Each data server 420A-N may receive this query from the query sever 410, and may search the supply data 450 available to the data server 420A-N. Each data server 420A-N may have a unique subset of the total supply data 450 from which to search. The supply data 450 may be stored at each data server 420A-N, or remotely from the data servers 420A-N.

After receiving the request or query from the query server 410, each data server 420A-N may return data or information to the query server 410 related to the query. In some embodiments, each data server 420A-N may have a partition or subset of a forecast model, and may use the forecast model in conjunction with the supply data 450 available to the data server 420A-N to forecast a supply to be returned to the query server 410. The returned information may include, for example, a total number of advertisement impressions or opportunities matching the attributes received from the query server 410. The information may include, for example, a set of sample advertisement impressions or opportunities matching the attributes received from the query server 410. As mentioned, in some embodiments, each query result may be represented as a set of supply samples, where each sample has a weight associated with the amount of supply it represents, and where the total supply for a query is the sum of the weights of the samples in the query result.

Each sample may include one or more attributes about the ad impression or ad opportunity. In some embodiments, all known attributes about the ad impression or opportunity sample may be included. Where the query server requests advertisement impression information that matches the attributes specified by an advertiser 205, each of the sample advertisement impressions or opportunities may have at least those attributes specified by the advertiser 205.

Each sample may also include a sample weight. The sample weight may indicate the number of ad impressions or opportunities like the sample that the data server 420A-N has. The total number of available ad impressions or opportunities may be calculated by taking the sum of the weighted samples.

As noted, in some embodiments, the query server 410 may specify that one sample be returned for every X number of matching/relevant ad opportunities. In these embodiments, the total number of available ad impressions or opportunities may also be calculated by taking the sum of the number of samples multiplied by the weight.

In some embodiments, it may be assumed that each of the data servers 420A-N has a generally even distribution of advertisement impressions or opportunities. In some of these embodiments, the sample weight may be uniform for each sample returned from one of the data servers, as the system may assume that each of the samples is equally likely to represent 1/(number of samples) of the total number of advertisement impressions or opportunities.

For example, data server 420C may receive the query from the query server 410. The data server 420C may have 100 advertisement impressions or opportunities matching the attributes specified by the advertiser. The data server 420C may return 10 samples from the 100 advertisement impressions. In some embodiments, it may be assumed that the 10 samples each represent 1/10 of the advertisement impressions available, and therefore, each advertisement sample may be weighted by 10. The total advertisement impressions available from data server 420C may be calculated by summing the weighted samples. In this example, the sum of the weighted samples is 10+10+10 . . . +10=10(10)=100.

If, in the above example, 20 samples are returned instead of 10, each of the samples may be weighted by 5. As such, the total advertisement impressions, which may be the sum of the weighted samples, is 5+5+5 . . . +5=20(5)=100.

As another example, consider where a query server 410 requests supply information for ad impressions with: Content Topic=Sports; Location=CA. Assume the query server 410 requests three weighted samples indicating the number of ad opportunities. Assume the data server has six ad impressions corresponding to this query:

I1: Content Topic=Sports; Location=CA; Gender=Male; Age Category=2; Behavior Tag=Politics . . .

I2: Content Topic=Sports; Location=CA; Gender=Female; Age Category=2; Behavior Tag=News . . .

I3: Content Topic=Sports; Location=CA; Gender=Male; Age Category=3; Behavior Tag=Politics . . .

I4: Content Topic=Sports; Location=CA; Gender=Female; Age Category=2; Behavior Tag=News . . .

I5: Content Topic=Sports; Location=CA; Gender=Male; Age Category=4; Behavior Tag=News . . .

I6: Content Topic=Sports; Location=CA; Gender=Female; Age Category=3; Behavior Tag=Politics . . .

The data server may then return only three samples, chosen at random from the set of ad impressions, with each sample being weighted two.

S1: Weight=2; Content Topic=Sports; Location=CA; Gender=Male; Age Category=2; Behavior Tag=Politics . . .

S2: Weight=2; Content Topic=Sports; Location=CA; Gender=Male; Age Category=3; Behavior Tag=Politics . . .

S3: Weight=2; Content Topic=Sports; Location=CA; Gender=Female; Age Category=2; Behavior Tag=News . . .

Samples may be randomly chosen. Samples may be manually or automatically chosen based on one or more characteristics, or may be chosen in any other way or combination of ways. For example, an algorithm or algorithmic component may be used that picks up the most relevant sample that represents the supply data and/or ad impressions in the data server.

In other embodiments, each data server and/or sample from a data server may not be uniform and may not have to be weighted the same. In some embodiments, sampling techniques may be used or otherwise incorporated to selectively determine the samples as representative of the total number of advertisement impressions or opportunities. For example, in some embodiments, the samples may perfectly subdivide the set of advertising impressions or opportunities into one or more subsets. For example, the advertiser may only specify “Content Topic” as “Sports.” Data server 420B may, for example, return two samples, both with “Content Topic” matching “Sports,” but a first with “Gender” being “Male” and a second with “Gender” being “Female.” In this example, the samples may not further specify any other attributes. Since all advertising impressions or opportunities may be divided into one of the two samples, the data server 420B may calculate an actual weight for each sample. Where the data server 420B has 100 advertisement impressions or opportunities matching “Sports,” the data server 420B may determine for certain that 55 of these advertisement impressions or opportunities are male, and therefore may weight the “Male” sample 55 and the “Female” sample 45. In some embodiments, the total number of advertisement impressions available for a particular data server may be represented as a sum of the weighted samples.

As mentioned, the gathered data regarding past impressions may be used by supply forecasting models for forecasting a supply of potential ad opportunities. Forecasting models may be, for example, created from or using ad logs like ad log 280 to model future supply in a supply forecasting engine, such as the supply forecaster 320. The ad log 280 may be in a feedback loop to understand ad opportunities which may be available. The ad log 280 may be and/or may store a listing of ad events in terms of ad impressions. For each impression, the attributes of the impression may be listed. In some embodiments, the ad impressions may be weighted, in that if the same impression or type of impression occurs multiple times, it may be represented in the ad log by one entry with a corresponding weight. The data in the ad log 280 may be analyzed for forecasting count and trends and the development of forecasting models.

The forecasting models created and/or modified by the ad log 280 may be stored in the ad log 280, the query server 410, and/or one or more of the data servers 420A-N. In some embodiments, the forecasting models are created and updated by the ad log 280. The forecasting models may be updated, for example, daily or at any given time period. The forecasting models may be updated with information received by and/or stored in the ad log 280.

A part or all of the forecasting model or models may, for example, be sent, uploaded, downloaded, and/or otherwise communicated by the ad log 280 to one or more of the data servers 420A-N. For example, each data server 420A-N may receive an updated forecasting model with an updated set of data from ad impressions logged during the previous period. This may, for example, occur daily. In some embodiments, the data servers 420A-N may each forecast a supply by receiving the query from the query server 410 and using the forecasting model to determine a projected supply of data. The query server 410 may receive from each data server 420A-N an actual forecasted supply for the data servers 420A-N, and may determine a total forecasted supply by merely aggregating the received forecasted supply from each data server 420A-N. In these embodiments, the query server 410 may not need to or actually receive raw data from the data servers 420A-N, but may merely receive a forecasted supply from each data server 420A-N. In some embodiments, the forecasting is done locally in each data server 420A-N. These systems may, for example, be useful where large amounts of raw data may be stored in each of the data servers 420A-N.

The creation, updating, adjustment, and/or communication of forecasting models may be done partially or completely offline and/or partially or completely online.

In other embodiments, a query server 410 may query a plurality of data servers 420A-N for raw supply data. This raw data may be received by the query server 410, and then applied or used with a forecast model to determine or otherwise forecast a supply using the historical data and/or trends. This may be useful, for example, where the forecast models are large and/or complex, and/or where small amounts of data are requested.

As shown in FIG. 3, once the data has been input into the supply forecasting model and a forecasted or otherwise determined supply estimate is obtained by the supply forecaster 320, the supply forecaster 320 may return the supply information to the campaign allocator 310. In other embodiments, raw data may be sent to the campaign allocator which may conduct the supply forecasting.

Where supply data is received by the campaign allocator 310, the campaign allocator 310 may proceed to determine how much of the supply may be allocated, if booked or reserved, to an ad campaign requested by the advertiser 205. This determination may require consulting or otherwise communicating with the campaign log 270 to gather, consider, and/or analyze information pertaining to other campaigns or advertisements already booked with the advertising system 140 and recorded in the campaign log 270.

The campaign log 270 may contain or store some or all information regarding any campaigns which have been booked or reserved with the advertising system 140. The campaign log 270 may additionally or alternatively contain or store some or all of the advertisements or other information to be displayed which relate to the booked or reserved ad campaigns or the advertisers who have booked or reserved the ad campaigns. The campaign log 270 may determine one or more allocation parameters for each advertising campaign. The allocation parameters may suggest how the campaign will consume ad impressions that match its requirements. For example, some ad campaigns may be created that consume every impression that the ad campaign qualified for. These may be called exclusive campaigns. Other campaigns may take a percentage of impressions they qualify for. This determination may be made based on parameters of the campaign when booked, such as by specifying if the campaign is an exclusive campaign and/or the relative proportion of the demand specified by the ad campaign to the size of its eligible supply.

The campaign allocator 310 may compare the identified supply received from the supply forecaster 320 with ad campaigns requesting or associated with part or all of the identified supply, and may determine what portion of the identified supply is actually available for a requested campaign. For example, the campaign allocator 310 may receive an indication from the supply forecaster 320 that there are 100 advertising opportunities available for a requested advertising campaign with the attributes specified by the advertiser 205. The campaign allocator 310 may determine what portion of those advertising opportunities are already accounted for by other campaigns already booked or reserved (such as campaigns stored in the campaign log 270 which specify, for example, identical attributes to those identified by the advertiser 205), as well as what portion of the advertising opportunities may be, but are not required to be, used by other campaigns already booked or reserved (such as campaigns stored in the campaign log 270 which specify, for example, overlapping but not identical attributes to those identified by the advertiser 205). The campaign allocator 310 may use certain template or other techniques for allocating supply where an overlap exists.

Using this information, the campaign allocator 310 may determine a number of likely available advertising opportunities, as well as a price for establishing the advertising campaign. Where fewer advertising opportunities are available than were requested by the advertiser 205, the campaign allocator 310 may indicate to the advertiser 205 that a request cannot be met. In either situation, the campaign allocator 310 may provide the advertiser 205 with an offer and an available supply for establishing the advertising campaign.

In some embodiments where a smaller supply exists than was requested by the advertiser 205, the campaign allocator 310 may request that the advertiser 205 remove or otherwise modify one or more of the attributes or ad campaign requirements to further broaden or narrow the number of ad opportunities. In some embodiments, prior to delivering this request to the advertiser 205, the campaign allocator 310 may request from the supply forecaster 320 an estimate of a supply if one or more of the attributes or ad campaign requirements were removed, and may return this estimate in a request to the advertiser 205. In other embodiments, the campaign allocator 310 may merely report whether it can accept or reject bookings based on the available inventory and the requested inventory.

If the advertiser 205 accepts the offer, the advertisements or other information for the advertiser 205 are gathered by the advertising system 140 and stored in the campaign log 270.

When a user, such as user 215 in FIG. 2, enters a search request, visits a web site, or otherwise generates an advertising opportunity, the ad serving system 260 may receive a request for an advertisement. The ad serving system 260 may gather information about the ad opportunity, such as the type of audience, the timing, the available space of an advertisement, etc., and may communicate with the campaign log 270 to identify an advertising campaign which meets the criteria of the advertising opportunity. An advertisement may be chosen from an ad campaign which meets the criteria of the ad opportunity. For example, an ad campaign with attributes which match the ad opportunity may be selected. The chosen advertisement from the selected ad campaign may be sent from the campaign log 270 to the ad serving system 260, and then to the user 215 or the user application 220. Alternatively, the advertisement may be sent directly from the campaign log 270 to the user 215 or the user application 220. The ad serving system 260 may then record the service of the advertisement in the ad log 280. As mentioned the supply data 450 may later be updated with this data regarding this advertisement opportunity and impression, for use with future advertising campaign booking requests or inquiries.

Where the query server 410 queries each of the data servers 420A-N, as shown in FIG. 4, it is possible that any one or more of the data servers 420A-N may not respond to the query. As the number of data servers 420A-N increases, the possibility for a failure increases. For example, one or more of the data servers 420A-N may be down for maintenance or due to a system failure. Alternatively or in addition, the network through which the request and data may be sent between the query server 410 and the data servers 420A-N may be inoperable or temporarily down. Alternatively or in addition, one or more of the data servers 420A-N may be receiving a data upload at the same time that the query from the query server 410 is sent, and therefore may not respond. An example of this may occur when one or more of the data servers 420A-N receive a daily (or any time period) update or refresh with ad impressions or opportunities experienced during the previous day (or time period). During the refresh operation, a data server may need to update its state and may not be available to process the queries temporarily. Additionally or alternatively, the query server 410 may have a specified time in which it expects to receive a response, and if it does not receive one in that time, the query server 410 may consider the query timed out or otherwise a failure. Heterogeneity of data servers response time may mean that a slowest data server response drives the overall query latency. Some queries may take much longer than others, and so the overall response of the campaign query may be significantly delayed. For instance, if there are 100 data servers, and 99 queries are answered within 1 second but the other query is answered in 10 seconds, the latency for the campaign query may become 10 seconds.

Data severs 420A-N may all be the same, similar, different. One or more data servers 420A-N may be uniform or may be different. Any combination of identical, similar, or different data servers is possible.

A query server 410 which does not receive data from all of the queried data servers 420A-N may respond in a number of ways. The query server 410 may declare a failure to supply the requested information to the campaign allocator 310. This may avoid a strain on the system by simply quitting the query when less than 100% response has been achieved. However, this may be less advantageous to an advertiser 205 who may choose not to book an advertising campaign, and may be unnecessary where the non-responsive data server(s) were only temporarily unavailable for a short period of time.

The query server 410 may alternatively retry the supply query request all over again, by re-querying all of the data servers 420A-N. This method may gather all information at one time, assuring that all responsive data servers 420A-N return the absolute most up to date information, and may further strive for 100% response. However, this method may lead to “infinite” latency if one or more data servers are down or non-responsive for a long period of time.

The query server 410 may, alternatively, continually retry only the non-responsive data servers 420A-N until all of the data servers 420A-N have responded. This method may reduce strains or unnecessary searching and querying by avoiding re-sending the query to data servers which have already responded, while also striving for 100% response rate. However, this method may also lead to “infinite” latency if one or more data servers are down or non-responsive for a long period of time.

The query server 410 may ignore slow or unavailable responses to the partition queries (when there are few). The query server 410 may adjust weights on the partial subset that is computed from the rest of the partitions.

Other systems and/or methods may incorporate one or more strategy or method in response to situations where one or more servers do not respond to a query from the query server 410. Some systems and/or methods may incorporate, for example, one or more aspects of a limited retry related to the number of times the query server 410 will re-send a query to the data servers 420A-N. For example. a system may retry on a configured number of times, but not an unbounded number of times. This may provide against latency problems where one or more servers is down for an extended or permanent period of time. The system and/or method may also, or alternatively, incorporate one or more aspects of a focused retry, which may relate to the number of data servers that the query server 410 may re-send queries to. For example, the query server 410 may only resend the query to non-responsive data servers, or data servers that timed out, and compute the overall supply query result when it obtains the samples from the set of data servers 420A-N. This may allow for a better throughput by avoiding repetition of data server queries, and may increase the probability of convergence in the presence of sporadic network problems. Some systems and/or methods may also, or alternatively, incorporate one or more aspects of adjusting the weights of returned samples or returned data. For example, returned data or samples may be adjusted by multiplying the data or sample weights by an inverse of the ratio of responsive data or data servers to an expected response if all data servers were responsive. This may allow for better throughput by avoiding repetition, and better latency because of a single-cycle (or limited cycle) execution.

A hybrid approach may also be possible, where a query server 410 may do a focused retry with a bound on the number of retry cycles. These may be specified as a configuration parameter. If there are partial samples, but enough of them, the samples may be reweighted and returned. A threshold may also be specified as a configuration parameter. Otherwise the query may be rejected. This may ensure a high throughput and a low latency though focused retry and limited number of retry attempts. This may also ensure a high availability by returning adjusted weight partial samples. A tradeoff between accuracy of supply forecasting and performance of supply forecasting may be managed, for example, by a parameter specifying the number of retries or retry cycles. A trade-off between accuracy of supply forecasting and availability of supply forecasting may also be managed, for example, by a parameter specifying the threshold of partial samples.

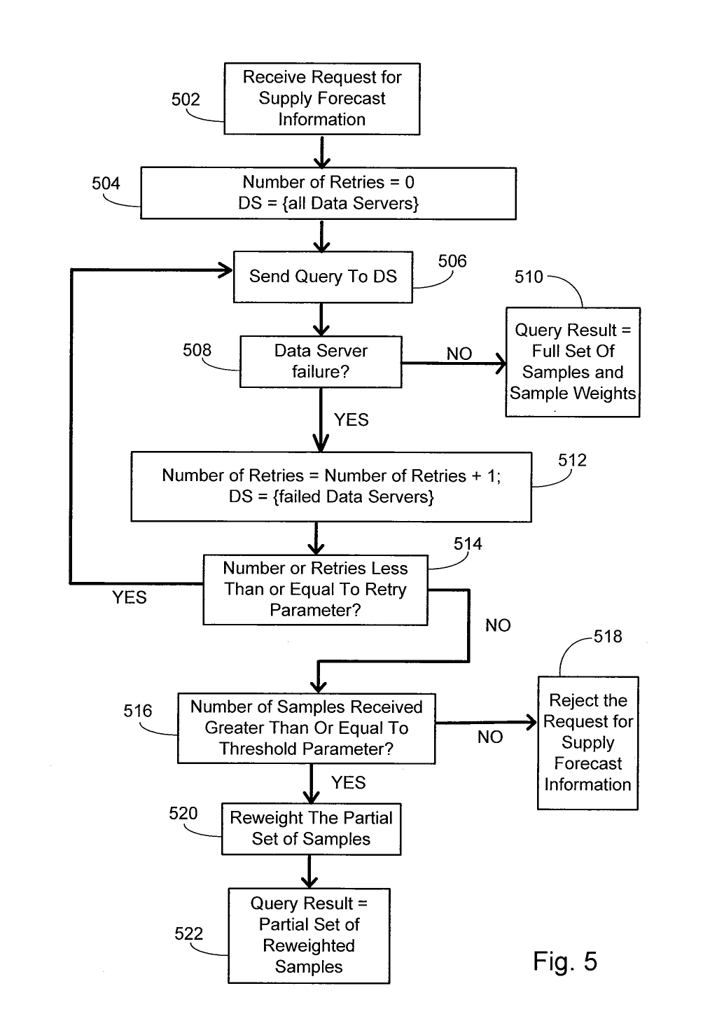

A system and method which may be useful in reacting to data server failures is shown in FIG. 5. The system and method in FIG. 5 may be a hybrid of one or more of the systems and methods discussed above, and/or may include additional or different features or steps.

The method of FIG. 5 begins at step 502, where a request for supply forecast information is received. At step 504, a Number of Retries is set at 0. The Number of Retries may refer to the number of times a query server 410 may query any of the data servers 420A-N. Because at step 504 the query sever 410 has not yet queried any of the data servers 420A-N, the Number of Retries may be set at 0. In addition, a set of servers DS may be set to include all of the data servers 420A-N. This may aid in or ensure that all of the data servers 420A-N will receive the query from the query sever 410.

At step 506, the query may be sent to all servers in the server set DS, which, as mentioned, may include all of the data servers 420A-N.

At step 508, data server failures may be detected, determined, identified, or otherwise discovered. These server failures may include, for example, any of those previously described, such as a time out or other failure.

In some embodiments, all errors, failures, or problems with data server responses may be detected through a simple time out mechanism at the query server 410. For example, when the query server 410 scatters the query to all of the data servers, it may set up and/or designate time out values for all of the data server queries. The time out values may represent an amount of time that the data server has to respond to the query before the query server 410 deems the data server non-responsive and/or to have experienced a time out and/or failure. The time out values may represent a deadline time, after which any data server which has not responded may be deemed non-responsive and/or to have experienced a time out and/or failure. The query server 410 may designate a particular time, such as by adding a response time to the time when the query was sent, by which all data servers 420A-N may have been expected to respond within if properly functioning. After that time, any data servers which did not respond may be deemed non-responsive and/or to have experienced a time out and/or failure. Alternatively or in addition, the query server 410 may begin a timer or a stopwatch which may run for a time period in which the query server 410 may expect a response from a functioning or receptive and responsive data server. After this time period, the query server 410 may deem all data servers which have not responded as non-responsive and/or to have experienced a time out and/or failure. Any other methods of setting up a time-out mechanism are possible.

Time out values and/or mechanisms may be identical for each data server, or may vary for one or more data server. In some embodiments, where not all data servers are sent the query at the exact same time, the time out values and/or mechanisms may be set from the time when the query is sent out, and may thus vary from data server to data server.

As mentioned, one or more of the data servers 420A-N may not respond to the query for a variety of reasons, and in these cases, the time out mechanism will trigger that failure. However, other methods of detecting failures may also be implemented. A time out mechanism as described may aid in alleviating latency problems due to the fact that the slowest data server response time drives the overall query latency.

If no server failures were detected at step 508, the method may move to step 510 where the query result obtained by the query server 410 is the full set of samples and sample weights. This query result may then be used with a forecast model or otherwise passed to the campaign allocator 310 as described above.

If server failures were detected, the method may move to step 512. In this step, the Number of Retries may be incremented by (1) one. In addition, the set of data servers may be set to only those data servers that have failed to provide any information in response to the query from the query server 410.

At step 514, the system may determine if the Number of Retries is less than or equal to a Retry Parameter. The Retry Parameter may specify how many retries or attempts to send or re-send queries to data servers 420A-N may be attempted by the query server 410 before the system will move on to another step. In many embodiments, the Retry Parameter will be set so that the query server 410 will re-send a query to any non-responsive data servers at least once, but this is not required.

The Retry Parameter may be set and/or modified by the advertising system 140. The Retry Parameter may be set or altered by the advertiser 205. In most embodiments, the Retry Parameter may be the same for all data servers 420A-N of the system. In some embodiments, however, the Retry Parameter may be different for different data servers 420A-N. For example, the Retry Parameter may be set shorter for data servers 420A-N with a history of substantial known failures.

If the Number of Retries is less than or equal to the Retry Parameter, the method may return to step 506 and send the query to the new set DS, which, as mentioned, may contain only those data servers that experienced a failure or otherwise failed to respond. The method then may proceed onward as described above.

If instead the Number of Retries is not less than or equal to the Retry Parameter, the method may proceed to step 516. In step 516, the system may determine whether the Number of Samples Received is greater than or equal to a Threshold Parameter. In other embodiments, the system may determine whether the Number of Samples Received is greater than the Threshold Parameter.

FIG. 5 describes step 516 as referring to Number of Samples Received. The Number of Samples Received may be characterized, for example, as a response level. Instead of, or in addition to, the Number of Samples Received, the response level may, for example, be or represent a measure of how many servers responded, what percentage or fraction (“percentage”) of servers responded, how many servers did not respond, what percentage of servers did not respond, how many servers failed, what percentage of servers failed, how much data was received, what percentage of data was received, how much data was not received, what percentage of data was not received, how much data expected to be received was received, what percentage of data expected to be received was received, how much data expected to be received was not received, what percentage of data expected to be received was not received, how many samples were received, what percentage of samples were received, how many samples were not received, what percentage of samples were not received, how many samples expected to be received were received, what percentage of samples expected to be received were received, how many samples expected to be received were not received, what percentage of samples expected to be received were not received, or any other value or indication of a level of response to the query.

The Threshold Parameter in FIG. 5 may refer to a minimum amount of data which is to be received by the query server 410 before the system is satisfied with the response. For example, the Threshold Parameter may refer to the minimum amount of data which is to be received by the query server 410 before the system is satisfied that the received data may be used, with confidence, as representative data for the whole system. The Threshold Parameter may be referred to as a threshold level. The threshold level may be or represent a designation of a minimum amount or percentage of servers that must respond or be responsive, for example, for the method to proceed or for the system to consider the data to be of a sufficient amount, for example, to be representative of all of the supply data 450; a maximum amount or percentage of servers that may not respond or fail; a minimum amount or percentage of data that must be received; a maximum amount or percentage of data that may not be received; a minimum amount or percentage of data expected to be received that must be received; a maximum amount or percentage of data expected to be received that may not be received; an minimum amount or percentage of samples that must be received; a maximum amount or percentage of samples that may not be received; a minimum amount or percentage of samples expected to be received that must be received; a maximum amount or percentage of samples expected to be received that may not be received; or any other value or indication of a level of response to the query

The Threshold Parameter may be set and/or modified by the advertising system 140. In some embodiments, the Threshold Parameter may be calculated or derived mathematically, taking into account desired confidence levels that the data received is representative of all of the data supply 450. The Threshold Parameter may be set automatically or manually. Alternatively or in addition, the Threshold Parameter may be set or altered by the advertiser 205.

Where the method considers a Number of Samples Received, the Threshold Parameter may be expressed as a number of samples, such as a desired number of samples. Where the method considers a number of responsive data servers, the Threshold Parameter may be expressed as a number of responsive data servers, such as a desired number of data servers. Where the method considers a percentage of samples received or responsive data servers, the Threshold Parameter may merely be a percentage or fractional value. In some embodiments, the Threshold Parameter or threshold level uses the same units of measurement as the response level.

Where the Number of Samples Received are not greater than or equal to the Threshold Parameter (or, for example, where the percentage of responsive data servers from those queried data servers is not greater than or equal to the Threshold Parameter), the method may move to step 518, where the request for supply forecast information is rejected.

Where the Number of Samples Received are greater than or equal to the Threshold Parameter (or, for example, where the percentage of responsive data servers from those queried data servers is greater than the Threshold Parameter), the method may move to step 520. At step 520, the partial set of received samples may be combined and reweighted. The weighting and/or reweighting of the partial set of received samples may be calculated and/or accomplished based on the response level and/or a comparison of the response level to the threshold level.

In some embodiments, each of the data servers 420A-N may be assumed to be roughly uniform and to have generally similar collections of advertisement impressions and opportunities. As such, in some embodiments, the received samples may be reweighted by simply multiplying each of the samples by the inverse of a ratio of the received samples to the total expected samples if all data servers had been responsive. In some embodiments, the received samples may be reweighted by simply multiplying each of the samples by the inverse of a ratio of the responsive data servers to the total number of queried data servers.

As an example, assume that 10 data servers are queried, with a request that each data server return 20 samples. Assume that 8 data servers are responsive and return 20 samples each. Note that the 20 samples each may be weighted when they are first sent by each of the data servers to the query server 410, indicating the number of advertisement impressions or opportunities in each data server that are represented by the returned sample. Assume that the maximum number of retries has been met and that the returned samples are greater than the Threshold Parameter. In this example, each of the returned weighted 160 samples (20 samples from each of the 8 responsive data servers) may be reweighted by multiplying the weighted samples by the inverse of the ratio of the received samples (160) to the total expected samples if all data servers had been responsive (200)=200/160=5/4. Note that the same ratios and methods of weighting may be applied where total counts, total supplies, or other values such as other values requested by a query server 410 may be desired, needed, or at issue.

In step 520, the samples may alternatively be weighted in a different manner to, for example, provide a more accurate extrapolation of the known sampling data. As mentioned, in some embodiments, data servers 420A-N may not be uniform. For example, some data servers 420A-N may store or access different amounts or types of data. The differences between the data servers 420A-N may be known. Where differences between data servers 420A-N may be known, these differences may be factored into weighting of data from the servers. Appropriate adjustments to any weights may be made based on, for example, corresponding meta-data with respect to the profile of the data servers. For example, one data server may have twice as many impressions as another, and this may be used to appropriately weight data.

For example, consider where 9 data servers have a first number of impressions, and a tenth data server has twice as many impressions as each of the first nine data servers, and where this difference is known. When the first nine data servers are responsive to a query from the query server and the tenth data server is not responsive, the received results from the first nine data servers may be weighted by multiplying the received samples and/or count by a ratio of the number or size of responses expected over the responses actually received. In this case, the number or size of responses expected may be 9 (1 each from the 9 data servers)+2 (double from the 10^{th} data server)=11. The number of responses actually received may be 9 (1 each from the first 9 data servers). As such, the received data maybe weighted by multiplying it by 11/9.

Similar calculations and/or adjustments may be made where other differences are known, such as where some data servers are known to have more of a type of ad impression or result than other data servers. Adjustments and/or weights may be calculated and applied, for example, to total counts, total forecasted supplies, weighted samples, number of samples, or any other values, such as those values and/or data requested by a query server 410 from one or more data servers 420A-N.

Where data servers are not uniform but a distribution is known, the known distribution may be used, for example, to weight or adjust values and/or data received accordingly. This may aid in or achieve an accurate estimate of a total supply. Other ratios and calculations are possible.

The weighting of samples and/or other supply data or information where less than all of the expected data is received may provide a way for the system to extrapolate known data to provide a full response to a query. The use of the Threshold Parameter in step 516 may ensure that at least a minimum amount of data is first received before the data is expanded, and as such, care may be taken in determining a Threshold Parameter.

Once the partial set of samples have been weighted, the method may move to step 522, where the query result is the partial set of reweighted samples. This query result may then be sent, for example, to the campaign allocator 310 or to a forecasting model for further analysis as previously described.

The method in FIG. 5 may provide a more streamlined approach to gathering information by implementing a limited number of “retries” or re-sent queries. In this manner, data servers experiencing a temporary failure may be re-queried, but the method may not proceed in perpetuity where one server is more permanently non-responsive. In addition, the method in FIG. 5 may provide focused “retry” in that the method may only re-query or re-send the query to those data servers that have not responded to any of the previous queries sent by the query server 410. This may allow for better throughput by avoiding the repetition of data server queries, and may increase the probability of convergence in the presence of sporadic network problems. The method in FIG. 5 may also provide a manner for adjusting the sample weights of those received samples, when the query server 410 receives enough, but not all, of the requested samples from the data servers 420A-N.

As a numeric example of the method and system in FIG. 5, suppose a parameter for the number of retries, or the Retry Parameter, equals 2, and the parameter for a partial sample threshold, or the Threshold Parameter, is 90%. Suppose the system has 20 data servers, and the query server asks each data server to produce 50 samples for a given campaign query for a total of 1000 samples.

Assume 15 of the data servers return 50 samples each within the timeout period, each with a weight of 100,000 (“100K”). The query server will then retry the 5 data servers that timed out, since the Retry Parameter has not been exceeded yet.

Assume that two previously non-responsive data servers return 50 samples each, with each sample having a pre-sample weight of 100K. The query server will retry the three other data servers one more time, since again the Retry Parameter has not been exceeded yet.

Assuming that 2 more data servers return 50 samples each with a pre-sample weight of 100K. Now, the Retry Parameter has been exceeded. The query server has 19×50=950 samples, which is greater than the Threshold Parameter. Because of this, the 950 received samples may be reweighted so that each one has a weight of (1000/950)*100K which equal approximately 105.2K.

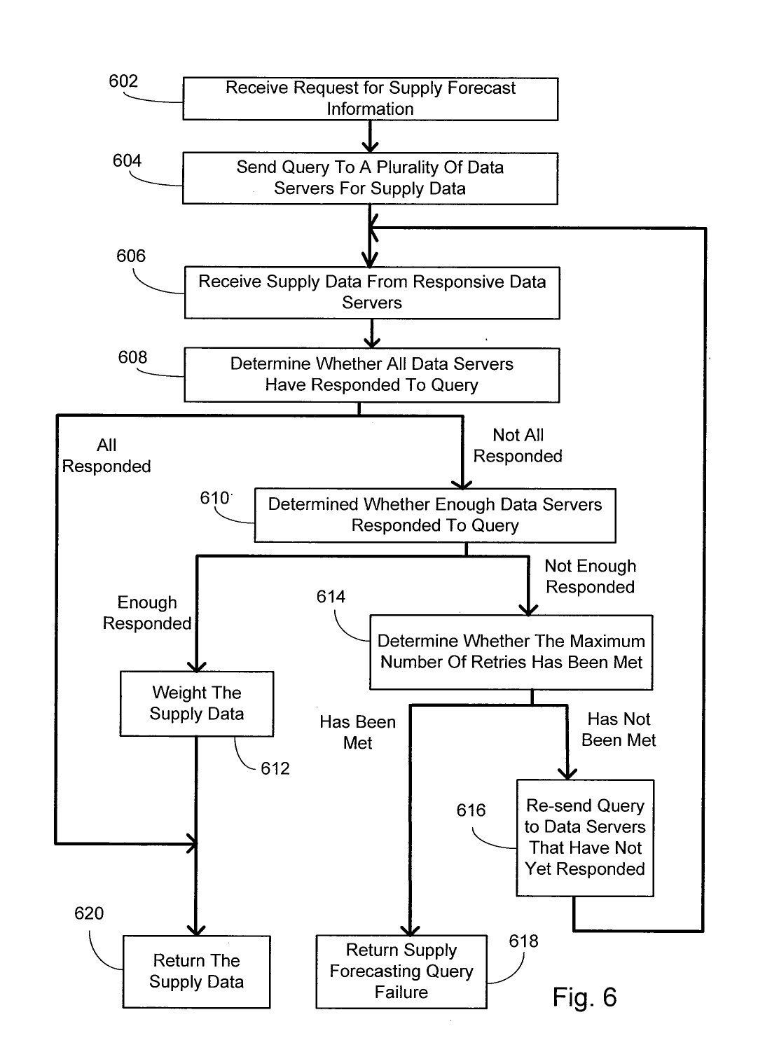

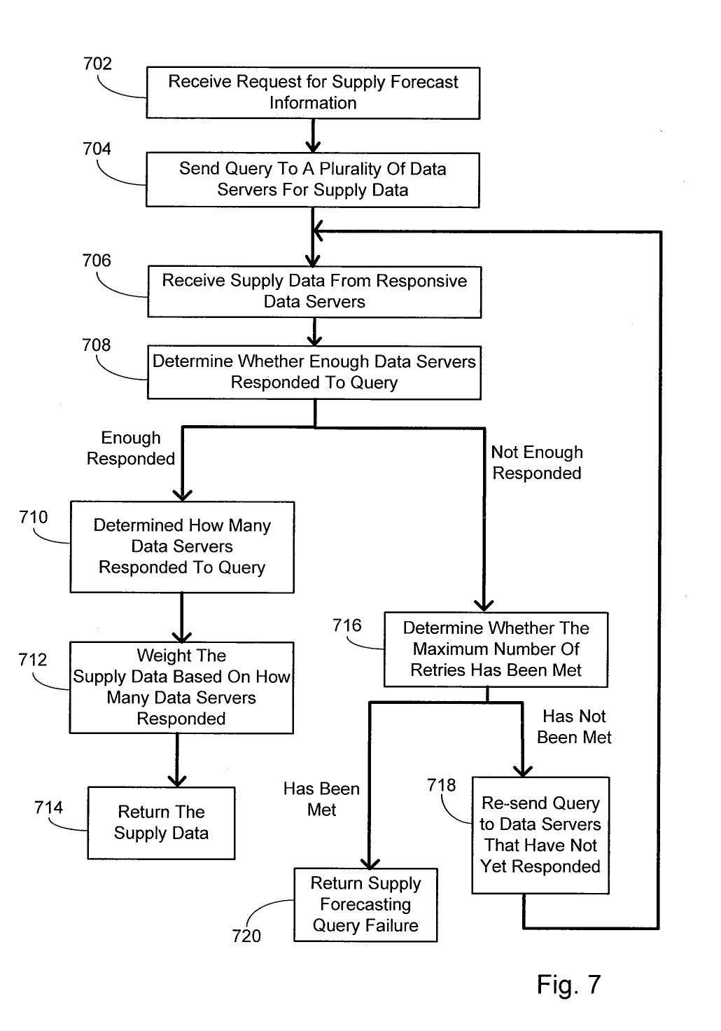

While this method depicts a system which retries only when the number of retries has not been exceeded and prior to any comparisons or checks with a threshold parameter, the system may, as shown in FIGS. 6 and 7, check to see if the Threshold Parameter has been exceeded also before conducting any retries, and may exit with partial samples if there are enough.

FIG. 6 depicts another example of a system and method which may be implemented by the supply forecaster 320 for receiving supply information or data from a plurality of data servers 420A-N.

In FIG. 6, the method begins at step 602, where a request for supply forecast information is received. This request may be received, for example, by the supply forecaster 320.

At step 604, a query is sent to a plurality of data servers for supply data. This query may be sent, for example, by the query server 410 to the data servers 420A-N.

At step 606, supply data is received from responsive data servers. None, some, or all of the data servers 420A-N may respond to the query.

At step 608, the system determines whether all data servers have responded to the query. This may be accomplished by determining whether any data servers 420A-N experienced any failures and/or timeouts, or, for example, whether an amount of data expected to be received was received. This may be characterized, for example, as a response level as described above, and other responses may be alternatively or in addition be measured or determined.

If all of the data servers have responded (or, for example, an amount of data expected to be received was actually received), the method proceeds to step 620, where the received supply data is returned in response to the request for supply forecast information. While this received supply data may be returned, such as, for example, to the campaign allocator 310, at step 620, the supply data may alternatively, or in addition, be used with forecasting models for predicting an available supply.

If not all of the data servers have responded to the query, the method proceeds to step 610. In step 610, the system determines whether enough data servers have responded to the query (or, for example, whether enough data or samples have been collected). For example, the system may compare the response to the query, such as the number of received samples or the number of responsive severs, to a value such as the Threshold Parameter. The system may determine that enough have responded where, for example, the Threshold Parameter is met or exceeded by the response to the query.

If enough data servers have responded, the system moves to step 612, where the supply data is weighted. The weighting of the supply data may, as described above, be weighted based on the response to the query. For example, the supply data may be weighted based on the number, or a percentage, of responsive data servers or received samples.

After step 612, the method moves to step 620 where the supply data is returned as described above for use with a forecasting model or by the campaign allocator 310.

If, at step 610, the query server 410 has not received a sufficient response, like, for example, when not enough data servers have responded to the query, the method moves to step 614. There, the system determines whether the maximum number of retries has been met. If the maximum number of retries has been met, the system returns a supply forecasting query failure at step 618. This may be returned, for example, to the campaign allocator 310, or may be passed directly to the advertiser 205.

If, at step 614, the maximum number of retries has not been met, the method moves to step 616 where the query is resent to the data servers that have not yet responded to a query from the system. The method may proceed back to step 606, where data may be collected from the data servers that receive the resent or second query. That data collected from the data servers responsive to the resent or second query may be added to or combined with the data originally collected from the data servers responsive to the initial query. At step 608, the system again considers whether all data servers have now responded.

If not, the system proceeds to step 610, where again the system determines whether enough data servers have responded. For example, the system may designate all data servers which responded to the initial query as responsive, and all data servers which did not as non-responsive. In response to the second query, the data server may, for those data servers previously considered non-responsive that responded to the second query, change the designation from non-responsive to responsive. In other embodiments, the response level is updated through each iteration of the method upon receiving data from the data servers in response to each query.

At any step throughout these methods, data servers 420A-N which have responded to any of the queries from the query server 410 may be designated, labeled, or otherwise identified as responsive servers. At any step throughout these methods, data servers 420A-N which have not responded to one or all of the queries from the query server 410 may be designated, labeled, or otherwise identified as non-responsive servers.

From step 610, the method again proceeds exactly as described above, and if not enough servers have responded and the maximum number of retries has not been met, the system sends a third query to the non-responsive data servers and again returns to step 606, continuing again through the method.

FIG. 7 depicts another example of a system and method which may be implemented by the supply forecaster 320 for receiving supply information or data from a plurality of data servers 420A-N.

The method begins at step 702, where a request for supply forecast information is received. The method proceeds to step 704, where a query is sent to a plurality of data servers for supply data. At step 706, supply data is received from responsive data servers. At step 708, the system determines whether enough data servers have responded to the query.

If enough have responded, the system moves to step 710, where the system determines how many data servers have responded to the query. At step 712, the system weights the supply data based on how many data servers have responded. This weighting may proceed in the manner described above, or any other similar manner. In circumstances where all data servers have responded (or an expected number of samples were received), the step may be skipped, or the samples or data may be weighted by a factor of 1. The method then proceeds to step 714, where the supply data is returned.

If, at step 708, not enough data servers responded to the query, the system then determines, at step 716, whether the maximum number of retries has been met. If the maximum number of retires has been met, the system moves to step 720, where a supply forecasting query failure is returned.

If, at step 716, the maximum number of retries has not been met, the method moves to step 718, where the query is re-sent to the data servers that have not yet responded to the query. The method then returns to step 706 and proceeds onward as discussed above.

In some embodiments, the system may, after querying data servers and receiving results, first check for a number of retries. When the number of retries has not been reached or exceeded, the system may repeat the querying and gathering of results with nonresponsive data servers. Where the number of retries has been reached, the system may check if the returned data meets a threshold value or not. If the threshold has been met or exceeded, the system may weight the results. If not, the system may return a failure. This system and/or method may be particularly useful where the number of retries is not large.

In other embodiments, the system may, after querying data servers and receiving results, first check to see if a threshold value has been met or not. If not, the system may check the number of retries. If the number of retries has not been met or exceeded, the system may resend the query to non responsive data servers. If the number of retries has been exceeded, the system may return a failure. Where, upon the first check of the threshold, the threshold value has been met or exceeded, the system may proceed to weight the samples and/or return a forecasted supply. This system and/or method may be particularly useful where there is a minimal likelihood of any data server failures.

In some embodiments, the system may not implement a threshold parameter, or may set the threshold parameter to a level indicating 100% response. In these embodiments, where no maximum number of retries is set, the query server may retry nonresponsive data servers until samples and/or responses are gathered from all queried data servers.

As discussed above, where the supply forecaster 320 is able to gather past data, the data may be used to generate pricing and supply information to be passed or sent from the campaign allocator 310 to the advertiser 205. However, in the case of a failure, the campaign allocator 310 may respond in a number of ways. The campaign allocator 310 may return to the advertiser 205 an error or failure message indicating the failure, and/or indicating that a campaign may not be available or may not be presently booked. The campaign allocator 310 may alternatively re-send the query to the supply forecaster 320. This re-sent query may appear to the supply forecaster 320 as a new query, and may be treated in the manner described above. Alternatively, the re-sent query may be recognized as a re-sent query, and any data saved by the supply forecaster 320 from the previous query may be re-used. In some embodiments, the campaign allocator may include a counter, and may re-send the query to the supply forecaster 320 a set number of times, after which the supply forecaster 320 may indicate the failure to the advertiser 205.

Any of the above described systems and/or methods may incorporate a request for more data and/or samples at any one time than are actually needed. For example, the query server 410 may, when querying each of the data servers 420A-N, request from each of the data servers 420A-N more samples or data than would actually be needed if all data servers 420A-N were responsive to the query. The additional samples may be used as extra samples when enough samples are collected, and/or may be used as insurance to work around possible problems that may arise with availability and/or performance of a subset of servers. The number of additional samples requested may be set by the system or manually set. The number of additional samples may be calculated using an algorithm. The number of additional samples may be a percentage of the total number of samples expected, or the threshold parameter.

The threshold parameter and retry parameter may each be set automatically or manually, and/or one may be set manually and another automatically. The threshold parameter and retry parameter may be set independently of each other. The threshold parameter and retry parameter may be set in conjunction, relation, and/or dependence on each other. The threshold parameter and/or retry parameter may be changed, altered, modified, tweaked, and/or otherwise adjusted, and the two parameters may be adjusted together, such as, for example, to optimize a level of availability and accuracy. The threshold parameter and retry parameter may be two adjustable units or knobs that may be used in conjunction at various steps of processing to achieve optimum response time and accurate results. This may aid in or ensure a highly availability and high performance forecasting system.

While the above described methods and systems may refer to a comparison and/or determination as to whether one element is greater than or equal to a second element, in some embodiments one or more of these comparisons may be replaced by a comparison and/or determination as to whether one element is greater than a second element. Similarly, comparisons and/or determinations described as being “greater than” may also be replaced with “greater than or equal to.” While the above described methods may refer to a comparison and/or determination as to whether one element is less than or equal to a second element, in some embodiments one or more of these comparisons may be replaced by a comparison and/or determination as to whether one element is less than a second element. Similarly, comparisons and/or determinations described as being “less than” may also be replaced with “less than or equal to.” Comparisons and/or determinations made which require an element to “exceed” a second element may be replaced by comparisons and/or determinations which require an element to “exceed or equal” a second element, and vice versa.

As described herein, an ad impression may be deemed to match attributes or ad campaign requirements when the ad impression has all of the attributes or ad campaign requirements. However, in some embodiments, it may be possible for the advertising system to allow for an advertiser to rank attributes or ad campaign requirements, or otherwise delineate between absolutely necessary attributes or ad campaign requirements and preferred, but perhaps not required, attributes or ad campaign requirements. In such embodiments, ad impressions may be deemed matches if all of the absolutely necessary attributes are or ad campaign requirements are met, or if a certain portion of ranked attributes or ad campaign requirements are met.

The methods and systems described herein may be used, for example, with IMS2, Yahoo!'s inventory management system for display advertising. The methods and systems described herein may not be limited to use with advertisements or with only online media. The methods and systems may be used with any system or model involving data or other information where a request is made to forecast a supply. For example, the methods and systems herein may be used to forecast room or seating on flights or other travel, or seating at events, like ballgames, or in other areas such as schooling or businesses. In some embodiments like these, the ad opportunities may instead be opportunities for seating availability or other availability, such as the availability of a product or service.

The above-described systems and methods may provide numerous advantages. For example, these systems and methods may provide a better throughput in querying data servers by avoiding the repetition of data server queries. Additionally, these systems and methods may increase the probability of convergence in the presence of sporadic network problems. Further, these systems and methods may avoid problems of “infinite” latency by recognizing when enough data has been accumulated to get an accurate estimate or assessment of opportunities available. The number of retries may be focused to avoid querying all systems, and may have a bound number of retry cycles to avoid the “infinite” latency problems. In these ways, the systems may manage trade-offs between accuracy of supply forecasting and performance of supply forecasting and/or the availability of supply forecasting. The present systems and methods may support high performance (latency less than 500 ms) and high availability for campaign availability and pricing determinations. The present systems may provide techniques for improved performance and availability in the presence of failures. The present systems and methods may alleviate problems or obstacles with performance and availability management, and may provide a trade-off between accuracy of query processing and performance and/or availability aspects. The present systems and methods may address availability and performance issues in a manner that preserves accurate determination of availability and pricing for ad campaigns, while at the same time ensuring high availability and low latency for booking campaigns. The advertisement system 140 and client applications 115, 125A-N may be one or more computing devices of various kinds, such as the computing device in FIG. 8. FIG. 8 illustrates an embodiment of a general computer system designated 800. Any of the components from the system 100 may include the computer system 800, such as the web application 125A, the standalone applications 115, 125B, the mobile application 125N, the advertising system 140, the ad serving system 260, the campaign log 270, the ad log 280, the inventory management system 250, the campaign allocation 310, the supply forecasting 320, the query server 410, and/or any of the data servers 420A-N. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system 800 may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 804 includes a cache or random access memory for the processor 802. In alternative embodiments, the memory 804 is separate from the processor 802, such as a cache memory of a processor, the system memory, or other memory. The memory 804 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts or tasks illustrated in the figures or described herein may be performed by the programmed processor 802 executing the instructions stored in the memory 804. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 800 may further include a display unit 814, such as a liquid crystal display (LCD), an organic light emitting diode (OLED), a flat panel display, a solid state display, a cathode ray tube (CRT), a projector, a printer or other now known or later developed display device for outputting determined information. The display 814 may act as an interface for the user to see the functioning of the processor 802, or specifically as an interface with the software stored in the memory 804 or in the drive unit 806.

Additionally, the computer system 800 may include an input device 816 configured to allow a user to interact with any of the components of system 800. The input device 816 may be a number pad, a keyboard, or a cursor control device, such as a mouse, or a joystick, touch screen display, remote control or any other device operative to interact with the computer system 800.

In a particular embodiment, as depicted in FIG. 8, the computer system 800 may also include a disk or optical drive unit 806. The disk drive unit 806 may include a computer-readable medium 810 in which one or more sets of instructions 812, e.g. software, can be embedded. Further, the instructions 812 may embody one or more of the methods or logic as described herein. In a particular embodiment, the instructions 812 may reside completely, or at least partially, within the memory 804 and/or within the processor 802 during execution by the computer system 800. The memory 804 and the processor 802 also may include computer-readable media as discussed above.

The present disclosure contemplates a computer-readable medium that includes instructions 812 or receives and executes instructions 812 responsive to a propagated signal so that a device connected to a network 820 can communicate voice, video, audio, images or any other data over the network 820. Further, the instructions 812 may be transmitted or received over the network 820 via a communication port 818. The communication port 818 may be a part of the processor 802 or may be a separate component. The communication port 818 may be created in software or may be a physical connection in hardware. The communication port 818 is configured to connect with a network 820, external media, the display 814, or any other components in system 800, or combinations thereof. The connection with the network 820 may be a physical connection, such as a wired Ethernet connection or may be established wirelessly as discussed below. Likewise, the additional connections with other components of the system 800 may be physical connections or may be established wirelessly.

The network 820 may include wired networks, wireless networks, or combinations thereof. The wireless network may be a cellular telephone network, an 802.11, 802.16, 802.20, or WiMax network. Further, the network 820 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of forecasting a supply using data from a plurality of data sources, the method comprising:
sending one or more queries for supply data to each of a plurality of data sources, wherein the one or more queries comprise at least one of an initial query sent first or a follow up query sent after the initial query;
gathering supply data from one or more of the plurality of data sources in response to the one or more queries;
incrementing a number of retries each time a query is sent to the plurality of data sources;
comparing the number of retries to a retry parameter before sending a follow up query to one of the plurality of data servers;
comparing the received supply data to a threshold parameter; and
designating the received supply data as a successful query result when the received supply data exceeds the threshold parameter without requiring supply data from all of the data sources.

2. The method of claim 1, further comprising:
weighting the received supply data only when the comparison of the received supply data to the threshold parameter indicates that the received supply data exceeds the threshold parameter and not all of the data sources have responded to the query, wherein the weighting is done before designating the received supply data as a successful query result.

3. The method of claim 2, wherein the steps of sending one or more queries, gathering supply data, incrementing a number of retries, and comparing the number of retries to the retry parameter are performed in listed order, the method further comprising:
sending, every time the comparison of the number of retries to the retry parameter indicates that the number of retries has not exceeded the retry parameter, the follow up query to each of one or more data servers of the plurality of data servers that did not respond to the any of the one or more queries;
repeating, in order and after sending the follow up query, the steps of gathering supply data, incrementing a number of retries, and comparing the number of retries to the retry parameter;
wherein the step of comparing the received supply data to the threshold parameter is performed only when the number of retries exceeds the retry parameter;
returning a query failure when the comparison of the received supply data to the threshold parameter indicates that the received supply data does not exceed the threshold parameter;
wherein the step of designating the received supply data as a successful query result consists of designating the weighted received supply data as a successful query result.

4. The method of claim 1, wherein the step of sending one or more queries for supply data to each one of the plurality of data sources comprises:
sending the initial query to each of the plurality of data sources; and
sending the follow up query to each of one or more data servers of the plurality of data servers that did not respond to the initial query, wherein the follow up query is sent when the comparison of the number of retries to a retry parameter indicates that the number of retries does not exceed the retry parameter.

5. The method of claim 1:
wherein the received supply data comprises one or more samples;
wherein each of the one or more samples comprises a weight representing a proportion of an amount of supply accessible to a one of the plurality of data servers which sent the sample; and
wherein the total supply for the one of the plurality of data servers is the sum of the weights of the samples received from the one of the plurality of data servers.

6. A method of forecasting a supply using data from a plurality of data servers, the method comprising:
receiving a request for a supply forecast;
sending a query for supply data to a plurality of data servers;
receiving the supply data from one or more of the plurality of data servers in response to the query; and
determining a response level based on the received supply data;
comparing the response level to a threshold level; and
computing the supply forecast based on the received supply data when the response level equals or exceeds the threshold level.

7. The method of claim 6, wherein the response level equals the threshold level when the response level indicates that all of the plurality of data servers have responded to the query.

8. The method of claim 7, further comprising:
re-sending the query for supply data to a subset of the plurality of data servers when the response level does not equal or exceed the threshold level, wherein the subset of server consist of data servers that have no responded to the query;
receiving the supply data from one or more of the subset of the plurality of data servers in response to the re-sent query;
updating the response level based on all received supply data;
comparing the updated response level to the threshold level; and
repeating the steps of re-sending the query, receiving the supply data from one or more of the subset of the plurality of data servers, updating the response level, and comparing the updated response level to the threshold-level when the updated response level does not equal or exceed the threshold level.

9. The method of claim 6, wherein a distribution of data over the plurality of data servers is not uniform, the method further comprising:
weighting the received supply data based on the response level and the distribution of data prior to computing the supply forecast when the response level equals or exceeds the threshold level and the response level indicates that not all of the plurality of data servers have responded to the query.

10. The method of claim 6, further comprising:
identifying data servers that did not respond to the query;
sending, prior to computing the supply forecast, a second query to the data servers that did not respond to the query when the response level does not equal or exceed the threshold level;
receiving supply data from one or more of the data servers in response to the second query;
updating the response level based on supply data received in response to the second query; and
repeating the step of comparing the response level to the threshold level;
wherein the supply forecast is computed only when the response level equals or exceeds the threshold level.

11. The method of claim 6:
wherein the determining a response level comprises determining a number of data servers that responded to the query;
wherein the threshold level represents a minimum number of responsive data servers needed before computing the supply forecast; and
wherein the comparing the response level to the threshold level comprises comparing the number of data servers that responded to the query to the minimum number of responsive data servers needed before computing the supply forecast.

12. The method of claim 6, wherein the response level corresponds to a number of samples received, and wherein the threshold level corresponds to a minimum number of samples needed before computing the supply forecast.

13. A system for forecasting a supply, comprising:
a query server comprising a non-transitory computer readable storage medium having stored therein data representing instructions executable by a programmed processor for forecasting a supply, the storage medium comprising:
instructions for receiving a request for a supply forecast;
instructions for sending a query for supply data to a plurality of data servers;
instructions for receiving the supply data from one or more of the plurality of data servers in response to the query; and
instructions for determining a response level based on the received supply data;
instructions for comparing the response level to a threshold level; and
instructions for computing the supply forecast based on the received supply data when the response level exceeds the threshold level without requiring receipt of supply data from all of the plurality of data servers.

14. The system of claim 13, wherein the storage medium further comprises:
instructions for identifying data servers that did not respond to the query;
instructions for sending, prior to computing the supply forecast, a second query to the data servers that did not respond to the query when the response level does not exceed the threshold level;
instructions for receiving supply data from one or more of the data servers in response to the second query;
instructions for updating the response level based on supply data received in response to the second query; and
instructions for repeating the step of comparing the response level to the threshold level;
wherein the supply forecast is computed only when the response level exceeds the threshold level.

15. The system of claim 13:
wherein the supply data comprises one or more samples chosen randomly or based on an algorithm that selects the most relevant samples from supply data for the data server responsive to the query;
wherein each of the one or more samples comprises a weight representing an amount of supply; and
wherein the total supply for one of the plurality of data servers is the sum of the weights of the samples received from the one of the plurality of data servers.

16. The system of claim 13, further comprising:
a campaign allocator configured to receive a request for information about booking an advertising campaign and to send the request for the supply forecast to the query server in response to the request for information about booking an advertising campaign; and
a campaign log configured to store data about booked advertising campaigns and advertisements related to the booked advertising campaigns.

17. The system of claim 16, further comprising:
an advertising serving system comprising a second non-transitory computer readable storage medium having stored therein data representing instructions executable by a programmed processor for delivering advertisements, the second storage medium comprising:
instructions for receiving a request for an advertisement to fill an advertisement opportunity;
instructions for gathering information about the advertisement opportunity;
instructions for comparing the information about the advertising opportunity to the data about the booked advertising campaigns;
instructions for selecting, based on the comparison, one of the booked advertising campaigns, wherein the data about the selected booked advertising campaign matches the information about the adverting opportunity; and
instructions for filling the advertising opportunity with an advertisement related to the selected booked advertising campaign.

18. A method of forecasting a supply using data from a plurality of data servers, the method comprising:
receiving a request for a supply forecast;
acquiring supply data, comprising:
sending a query for supply data to data servers that have not responded to any queries;
receiving supply data from one or more of the data servers in response to the sent query;
designating data servers that responded to the query as responsive data servers;
comparing a number of the responsive data servers to a threshold parameter;
computing the supply forecast when the number of responsive data servers exceeds the threshold parameter;
determining if a maximum number of queries have been sent to any of the data servers when the number of responsive data servers does not exceed the threshold parameter;
repeating the steps of acquiring supply data, computing the supply forecast, and determining if a maximum number of queries have been sent, when the number of responsive data servers does not exceed the threshold parameter and the maximum number of queries have not been sent to any of the data servers;
delivering a query failure message when the number of responsive data servers does not exceed the threshold parameter and the maximum number of queries have been sent to any of the data servers; and
delivering the computed supply forecast when the number of responsive data servers exceeds the threshold parameter.

19. The method of claim 18, wherein the received supply data from each responsive data server comprises one or more samples, wherein each of the one or more samples represent an example advertising opportunity and is weighted an amount indicating a portion of a supply the responsive data server has, wherein the one or more samples are chosen randomly or based on an algorithm that selects the most relevant samples, and wherein a sum of the samples for the responsive data server indicates a total supply the responsive data server has.

20. The method of claim 19, further comprising:
reweighting the one or more samples from each responsive data server prior to computing the supply forecast only when the number of responsive data servers exceeds the threshold number and not all of the queried data servers have responded to the query;
summing the reweighted one or more samples only when the number of responsive data servers exceeds the threshold number and not all of the queried data servers have responded to the query; and
summing the received one or more samples without reweighting the one or more samples only when all of the queried data servers have responded to the query.

21. The method of claim 20, wherein reweighting the one or more samples from each responsive data server comprises:
determining a ratio of a number of received samples to a number of samples expected if all data servers were responsive; and
multiplying the one or more samples from each responsive data server by an inverse of the ratio.

22. The method of claim 18, wherein the threshold parameter and the maximum number of retries are adjusted during the method to achieve an optimum response time and accurate results.
